(19) United States
(12) Patent Application Publication
(10) Pub. No.: US 2014/0310057 A1
(43) Pub. Date: Oct. 16, 2014

(54) MANAGEMENT OF SUBSCRIBERS OF A MOBILE COMMUNICATIONS NETWORK

(71) Applicant: TELIASONERA AB, Stockholm (SE)

(72) Inventor: Anders SODERLIND, Timra (SE)

(73) Assignee: TELIASONERA AB, Stockholm (SE)

(21) Appl. No.: 14/249,618

(22) Filed: Apr. 10, 2014

(30) Foreign Application Priority Data
Apr. 11, 2013 (FI) 20135351

(51) Int. Cl. G06Q 30/02

(52) U.S. Cl. CPC G06Q 30/0201
USPC 705/7.29

(57) ABSTRACT

A method and system for managing subscribers in a mobile communication network, the method includes receiving, in a server, predetermined subscriber specific information from at least one of the following: charging system, mobile communication network, mobile communication device; valuing each received piece of information according to a predetermined valuing scheme on a subscriber basis; aggregating the values in order to determine a value rep-resenting subscriber satisfaction in the mobile communications network on the subscriber basis; and determining one or more subscribers, whose subscriber satisfaction value is below a predetermined level, by comparing the value representing subscriber satisfaction to the predetermined level.

### TECHNICAL FIELD

The invention concerns in general the technical field of mobile communications systems. Especially the invention concerns management of subscribers of the mobile communications network.

### BACKGROUND OF THE INVENTION

End users within a communications network expect to receive quality of service, which meet their needs. In the current communications environment a reason for dissatisfaction by the customer side may origin from multiple sources being involved in the communication, such as a client terminal and a network and any operations therein. However, usually the party receiving the complaints from a client is the telecom operator.

There are developed multiple solutions to monitor the quality of service in a communication network. A typical approach is that quality of different components of the mobile communications chain is measured and evaluated. For example, the communication network, client terminal and/or service functionalities may be diagnosed. On the basis of the measured information it can be made conclusions, on a general level, how the network and any other component operate, but this does not reflect anyhow with the satisfaction on a personal level, i.e. a perceived subscriber experience. Moreover, the state of the art approach has a problem that at least some of the measured aspects, or more specifically the technical problems as evaluated within the communication channel, may not be anyhow seen, or experienced, by the subscriber even if the quality of the measured aspects would have been poor in a technical sense.

Thus, more sophisticated methods are needed to get a view on quality of a service experienced by a subscriber. It is especially important to get the understanding on a subscriber satisfaction level, so that a telecom operator can take preventive measures in time in order to keep the customership with a specific subscriber.

### SUMMARY OF THE INVENTION

An objective of the invention is to present a method, a system and a server for managing subscribers of a mobile communications network. Another objective of the invention is that the method, the system and the server enable to define subscriptions, which are experiencing non-acceptable level of service within the network.

The objects of the invention are reached by a method, a system and a server as defined by the respective independent claims.

According to a first aspect, a method for managing subscribers of a mobile communication network is provided, which method comprises steps of receiving, in a server, predetermined subscriber specific information from at least one of the following: charging system, mobile communication network, mobile communication device; valuing, in the server, each received piece of information according to a predetermined valuing scheme on a subscriber basis; aggregating, in the server, the values in order to determine a value representing subscriber satisfaction in the mobile communications network on the subscriber basis; and determining one or more subscribers, whose subscriber satisfaction value is below a predetermined level, by comparing the value representing subscriber satisfaction to the predetermined level.

According to a second aspect, a system for managing subscribers of a mobile communication network is provided wherein the system comprises the mobile communication network; a charging system; at least one mobile communication device used by the subscriber and a server. The server is configured to receive predetermined subscriber specific information from at least one of the following: charging system, mobile communication network, mobile communication device; value each received piece of information according to a predetermined valuing scheme on a subscriber basis; aggregate the values in order to determine a value representing subscriber satisfaction in the mobile communications network on the subscriber basis; and determine one or more subscribers, whose subscriber satisfaction value is below a predetermined level, by comparing the value representing subscriber satisfaction to the predetermined level.

According to a third aspect, a server for managing subscribers of a mobile communication network is provided wherein the server comprises one or more processors and one or more memories. The server is configured, by executing by the one or more processors a computer program code stored in the one or more memories, to receive predetermined subscriber specific information from at least one of the following: charging system, mobile communication network, mobile communication device; value each received piece of information according to a predetermined valuing scheme stored in the one or more memories on a subscriber basis; aggregate the values in order to determine a value representing subscriber satisfaction in the mobile communications network on the subscriber basis; and determine one or more subscribers, whose subscriber satisfaction value is below a predetermined level, by comparing the value representing subscriber satisfaction to the predetermined level.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a data structure according to an example of the invention, and

FIG. 2 illustrates a system according to an example of the invention.

### DETAILED DESCRIPTION

The idea of the current invention is that detailed subscriber satisfaction can be determined and presented on a subscriber basis so that the service provider, i.e. the telecom operator, may improve its services. In the broadest sense the invention provides a mechanism to monitor a service level experienced by a subscription and to find out the subscriptions, who have not received a satisfactory quality of service.

According to the invention one or more parameters representing service aspects for a subscription in the communication chain are determined. The quality of service with respect the one or more parameters are configured to be monitored on a subscription, i.e. customer, basis. In response to the monitoring a value for each of the parameter is defined on a basis of a predetermined value scheme. By aggregating the separate values, e.g. by summing up the values, a total value representing subscriber satisfaction can be defined.

The duration of the monitoring can be arranged according to the needs. For example, it is possible to set up the monitoring for e.g. one day or month and as a result the telecom operator may get information, which subscriber or subscribers has experienced low quality of service. The duration of the monitoring can be continuous or periodical per subscriber so that the operator may adjust the resources needed for monitoring.

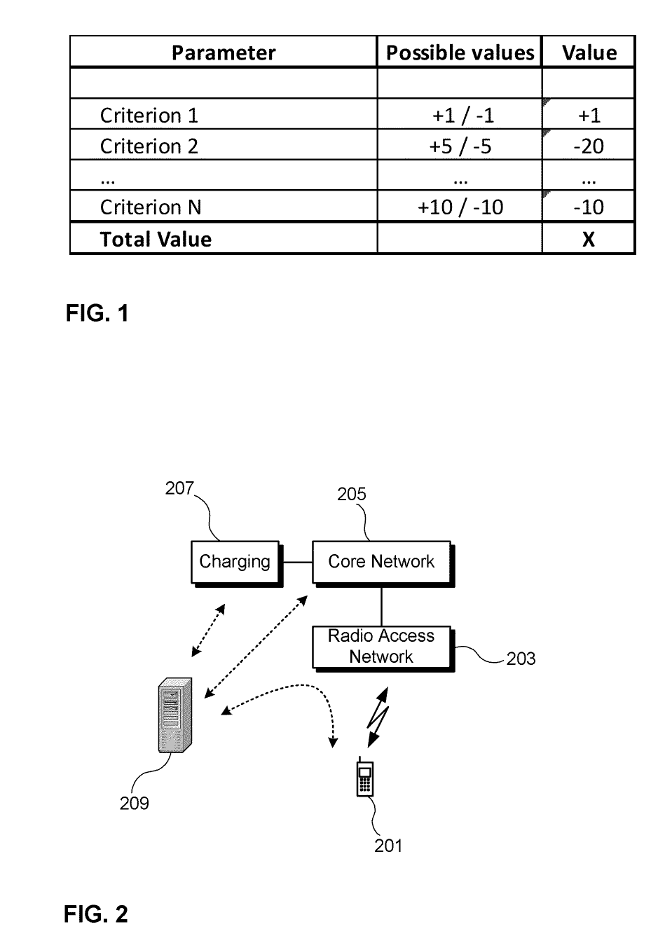

FIG. 1 illustrates an example of a structure of the information, e.g. parameters, to be collected. According to the example there can be multiple criteria (Criterion 1, Criterion 2, . . . , Criterion N) set as parameters through which the monitoring of service level the subscriber is experiencing can be arranged. The criteria e.g. may be the following:
Call succeeded or not
Reconnection of call during a predetermined period of time from termination
Data session succeeded or not
Error in termination of the data session
No IP address or DNS answer within a predetermined period of time
Handovers during a predetermined service (e.g. during streaming of data)

For each of the criteria is given a value according to a predetermined scheme. The scheme can be based, for example, to a simple setup i.e. if the service has succeeded, a certain value is given and if the service has not succeeded, another value is given. The scheme may follow any other rules. One advantage of the invention is that the telecom operator may vary the values of different criteria according to needs in order to emphasize certain aspects as regards the service quality if needed. Additionally, the telecom operator may give different weighting factors to different monitored parameters. Furthermore, the telecom operator may filter or sort received information in order to emphasize desired aspects in the monitoring.

The monitoring of the mentioned parameters may be arranged in multiple ways. According to an example of the invention the parameter representing call connection may be received into the monitoring system from the charging data records created in the mobile communication network, as the charging data records (CDR) are configured to carry information on each of the voice call connection, such as fault codes relating to the call in question but also information on the handset type and location of the handset during the call. The charging data records may be identified on a subscriber basis by a MSISDN number, which is embedded in the CDR in order to direct the charging information to the correct subscriber in the charging system. Furthermore, information to the monitoring system may be received from a probe system, which is generally understood as a key juncture in a network for a purpose of monitoring or collecting data about network activity or terminal usage towards access point and connected network. Probing may e.g. be used when end-to-end connectivity from a first terminal to a second terminal is being analyzed. Further, the probe system may provide information relating to call establishment between two parties, success of data sessions, termination of data session, receipt of IP address or DNS answer within a predetermined period of time, handovers. Still further information may be received from customer relationship management systems (CRM), which may comprise information relating e.g. to refill of pre-paid account of a subscription.

As can be seen it is possible to monitor many aspects relating to a subscriber. The information is available for the monitoring system within the network on a subscriber basis, because the subscription information is collected in the network. The subscription in the mobile communication network typically refers to a SIM (subscriber identity module) card in the network onto which the subscriber account is based on. The SIM card is typically a physical smart card, but the same identity can be implemented in any other way, such as virtually by means of software code, in the communications network. In general, the sources of information providing data for the evaluation of the subscriber satisfaction are linked together with one or more identities so that the subscriber information for a specific subscriber can be found.

Moreover, one possible source of information is the handset, i.e. user equipment. It is possible to install so-called handset agents in the terminal, which may collect information to the user behavior or how the network is experienced by the terminal, such as signaling levels. The information may be conveyed to the network.

The monitoring may be arranged in a manner that information from at least one or more of the mentioned sources are received, and thus monitored.

In the communications network there can be a server that is configured to access to information from one or more of the mentioned sources of information and produce the information as described by executing computer program code in a processor of the server. This causes the server to operate in a manner that it is possible to produce the mentioned information on a subscriber basis. The information may be used by the telecom operator in order to find the subscriber who have experienced service level, which is below a predetermined level set by the telecom operator. Additionally, by means of the information the telecom operator may find fault information in the network. For example, it may be determined that a data connection with a certain terminal does not work properly in a certain network cell. That helps in determining the reason for such a behavior in the network.

As the total value representing a subscriber satisfaction is defined, the telecom operator may compose a list of the subscriptions, i.e. customers, and by sorting the list to find out the subscribers who have experienced non-acceptable level of service quality (i.e. below a predetermined level) within the network. With this information the telecom operator may start searching the reason, why certain subscribers does not receive service, which is good enough, and taking counter-measures in order to improve the situation.

FIG. 2 illustrates an example of the implementation of the system according to the invention. Therein a mobile communication device 201 comprising a subscription identity module is residing in a mobile communication network and connected to the network through a radio access network 203, which in turn is connected to a core network 205, which controls and manages the operation of the mobile communication network. The core network 205 may collect information on the subscriber. Furthermore, the charging system 207 is also arranged to the system in order to collect and maintain charging related information of the subscribers. The charging system 207 may e.g. be coupled to the core network, or implemented directly in the core network. FIG. 2 does not illustrate any elements within the radio access network 203, core network 205 and charging system 207 for clarity reasons and as they are generally known from the state of the art information. Furthermore, the system according to an example of the invention comprises a server 209, which is configured to monitor predetermined parameters from predefined sources on a subscription basis. In FIG. 2 it is illustrated the server 209 receives information from the mobile communication device 201 through the mobile communication network, from the core network 205 and from the charging system 207 (arrows with dashed lines). The parameters may, for example, be selected as described in the description above.

The server according to an example of the invention may comprise a communication interface, such as wireless or wired modem, by means of which a communication channel can be established with different entities. Moreover, the server 209 may comprise one or more processors in order to execute computer program code stored in one or more memories of the server 209. By executing the computer program code the server 209 is caused to operate as described. The server 209 may also comprise input/output means in order to access the server 209 by an operator of the server.

Some advantageous embodiments according to the invention were described above. The invention is not limited to the embodiments described. The inventive idea can be applied in numerous ways within the scope defined by the claims attached hereto.

1. A method for managing subscribers of a mobile communication network, the method comprising
receiving, in a server, predetermined subscriber specific information from at least one of the following: charging system, mobile communication network, mobile communication device,
valuing, in the server, each received piece of information according to a predetermined valuing scheme on a subscriber basis,
aggregating, in the server, the values in order to determine a value representing subscriber satisfaction in the mobile communications network on the subscriber basis, and
determining one or more subscribers, whose subscriber satisfaction value is below a predetermined level, by comparing the value representing subscriber satisfaction to the predetermined level.

2. A system for managing subscribers of a mobile communication network, the system comprising
the mobile communication network;
a charging system;
at least one mobile communication device used by the subscriber;
a server;
wherein the server is configured to
receive predetermined subscriber specific information from at least one of the following: charging system, mobile communication network, mobile communication device,
value each received piece of information according to a predetermined valuing scheme on a subscriber basis,
aggregate the values in order to determine a value representing subscriber satisfaction in the mobile communications network on the subscriber basis, and
determine one or more subscribers, whose subscriber satisfaction value is below a predetermined level, by comparing the value representing subscriber satisfaction to the predetermined level.

3. A server for managing subscribers of a mobile communication network, the server comprising
one or more processors
one or more memories
wherein the server is configured, by executing by the one or more processors a computer program code stored in the one or more memories, to
receive predetermined subscriber specific information from at least one of the following: charging system, mobile communication network, mobile communication device,
value each received piece of information according to a predetermined valuing scheme stored in the one or more memories on a subscriber basis,
aggregate the values in order to determine a value representing subscriber satisfaction in the mobile communications network on the subscriber basis, and
determine one or more subscribers, whose subscriber satisfaction value is below a predetermined level, by comparing the value representing subscriber satisfaction to the predetermined level.
